(19) United States
(12) Patent Application Publication
(10) Pub. No.: US 2026/0111973 A1
(43) Pub. Date: Apr. 23, 2026

(54) METHOD AND SYSTEM FOR PROVIDING A SUCCESSFUL PERFORMANCE OF AN AGRICULTURAL PROCESS BY OPERATING AN AGRICULTURAL WORKING MACHINE BY A CUSTOMER

(71) Applicant: CLAAS Omaha Inc., Omaha, NE (US)

(72) Inventors: Reinhard Hesse, Versmold (DE); Patricio Frangella, Columbus, IN (US); Jordan Hellbusch, Omaha, NE (US); Ray Ochsner, Papillion, NE (US); Jeff Tilden, Columbus, IN (US); Mark Turnis, Treynor, IA (US); Scott Wellensiek, Harsewinkel (DE); Christoph Tetzlaff, Omaha, NE (US); Robin Monkenbusch, Rheda-Wiedenbrück (DE); Adam Lee Haworth, Louisville, NE (US)

(73) Assignee: CLAAS Omaha Inc., Omaha, NE (US)

(21) Appl. No.: 19/294,172

(22) Filed: Aug. 7, 2025

Related U.S. Application Data
(63) Continuation of application No. PCT/IB2023/061302, filed on Nov. 9, 2023.

(30) Foreign Application Priority Data
Feb. 9, 2023 (DE) 10 2023 103 208.9

(51) Int. Cl. G06Q 50/02; A01B 76/00; B60S 5/00; G06Q 10/20

(52) U.S. Cl. CPC G06Q 50/02; A01B 76/00; G06Q 10/20; B60S 5/00

(57) ABSTRACT

A method and system for providing a successful performance of an agricultural process by a customer operating an agricultural working machine. A digital service module, which is hosted on a server, comprises a success guarantee management system to improve or maximize the probability of a successful agricultural process. The occurrence of a technical problem of the agricultural machine may require technical service to be provided to the agricultural working machine. The success guarantee management system derives for each service event target performance criteria. The target performance criteria may be used as highly weighted optimization criteria within the optimization strategy in order to maximize the probability of a successful agricultural process by meeting the optimization criteria.

### CROSS REFERENCE TO RELATED APPLICATIONS

This application is a bypass continuation and claims priority to PCT Application No. PCT/IB2023/061302 (published as WO/2024/165903) filed on Nov. 9, 2023, which claims priority to German Patent Application No. 10 2023 103 208.9 filed Feb. 9, 2023, the entire disclosure of both of which are hereby incorporated by reference herein. This application is also related to U.S. application Ser. No. ______ (attorney docket no. 15191-24025A (P05768/8)), U.S. application Ser. No. ______ (attorney docket no. 15191-24027A (P05770/8)), U.S. application Ser. No. ______ (attorney docket no. 15191-24028A (P05771/8)), U.S. application Ser. No. ______ (attorney docket no. 15191-24029A (P05772/8)), U.S. application Ser. No. ______ (attorney docket no. 15191-24030A (P05773/8)), U.S. application Ser. No. ______ (attorney docket no. 15191-24031A (P05774/8)), and U.S. application Ser. No. ______ (attorney docket no. 15191-24032A (P05775/8)), each of which are incorporated by reference herein in their entirety.

### TECHNICAL FIELD

The present invention relates to a method and system for providing technical service to an agricultural working machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Agricultural working machines regularly need technical service, including repairs, changes of damaged and worn parts and upgrades. This technical service is often done at dedicated servicing locations. A customer owning an agricultural working machine in need of such a service then has to move the agricultural working machine to the servicing location. A service technician at the servicing location locates a technical problem, orders spare parts to fix the problem and provides the needed services to fix the problem. Afterwards, the customer may pick up the agricultural working machine.

Technical problems of agricultural working machines often occur during use and lead to a downtime of the agricultural working machine. Downtime for agricultural working machines may have significant negative impacts on farmers and agricultural operations. When a machine is unable to perform its intended tasks, it may result in decreased productivity, lost revenue, and increased operating costs. In some cases, downtime may also lead to missed deadlines for planting or harvesting crops, which may result in reduced yields and lower quality produce. Furthermore, prolonged downtime may result in additional wear and tear on the machine, which may further increase the likelihood of future breakdowns and reduce the lifespan of the equipment. Therefore, minimizing downtime is crucial for maintaining the efficient and profitable operation of agricultural businesses.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an overview of the disclosed method in use.

FIG. 2 illustrates an overview of the components assigned to the disclosed method.

FIG. 3 illustrates an overview of the flow of data between the components of FIG. 2.

### DETAILED DESCRIPTION

As discussed in the background, downtime for agricultural working machines may have significant negative impacts. In this regard, it may be a challenge to improve the situation, as the agricultural processes, that are to be performed by the agricultural working machines in question, often impose a time pressure onto repair works, which time pressure is often dynamic, unpredictable, and potentially different for each and any agricultural process with its individual and unique environment.

In view of this complex and dynamic situation, it may be a challenge for the provider of the technical services to keep promises that may have been made to the customer, regarding completion time, quality level and costs.

Thus, in one or some embodiments, a system and method are disclosed to provide a success guarantee to the customer with the support of a digital service module, which may be hosted on a server. For improving, such as maximizing, the probability of a successful agricultural process, the digital service module may comprise a success guarantee management system.

One of the major drawbacks when aiming for a successful performance of an agricultural process is the occurrence of a technical problem of the agricultural machine, which may require the provision of a technical service to the agricultural working machine. Thus, the disclosed system and method may address this.

In order to define “success” in this context, it is first to be evaluated, which targets are actually achievable when taking some or all of the relevant parameters into account. In this respect, the success guarantee management system may define target performance criteria by, which may represent the targeted performance in view of any one, any combination, or all of: time; quality level; and costs. If the target performance criteria are met, the performance of the technical service and thereby the performance of the agricultural process may be considered successful.

If, for example, the service event to be performed requires any one, any combination, or all of certain service technicians, certain tools, and certain spare parts, which may have to be transported to the agricultural working machine, a minimum completion time for the service event may be estimated by the digital service module.

In addition, the success guarantee management system may also estimate the necessary and appropriate quality level, in which the service event is to be implemented. In one or some embodiments, the expression “quality level” means, for example, that the service may be performed with different levels of durability. A defect belt, for example, may be exchanged with a new belt, which may correspond to a maximum quality level, or may be provisionally repaired by using a special adhesive, which may correspond to a lower quality level in the above noted sense. For the quality level, a quality scale may be used, such as defined as a range from 1 to 10.

In one or some embodiments, the success guarantee management system may estimate an appropriate quality level, such as in view of the information about the agricultural process (e.g., about the working progress of the agricultural working process). For example, in the event that the agricultural process is almost completed and in the event that it appears to be raining soon at the location of the agricultural working machine, the digital service module may automatically propose a low quality level as a first target performance criteria, as the belt only has to function for a short period time and due to the weather situation a short completion time as a second target performance criteria. The target performance criteria regarding the costs to complete the technical service may well be defined by the customer, which may be stored as a default value in the database. In this regard, one or more factors, such as any one, any combination, or all of: one or more aspects of the agricultural working machine (e.g., the defect); one or more aspects of the agricultural working process (e.g., the amount of completion of the agricultural working process); or one or more aspects of the environment (e.g., the weather at the location of the agricultural working machine) may be used by the digital service module to automatically determine the quality level as a target performance criteria (such as the first target performance criteria).

In one or some embodiments, the success guarantee management system may be responsible for the generation and management of the target performance criteria. After having automatically established the target performance criteria, those target performance criteria may be applied to a multi-target optimization strategy as highly weighted optimization criteria, as will be explained below.

The disclosed method and system may heavily rely on the digital service module automatically coordinating the intended technical service effectively based on the optimization strategy, such that the probability for success in the above noted sense is improved or maximized.

In particular, Thus, in one or some embodiments, a method and system are disclosed for the technical services of agricultural working machines to be reorganized such that service technicians with service vehicles are loaded with the right tooling and the needed parts to perform the services in a synchronized manner in order to execute the service event directly at the agricultural machine in the field. The parts may arrive at the customer's location just-in-time or a meeting between the part runners and the service vehicles may be arranged. This basic concept may allow executing a service in a single run at the location that the agricultural working machine currently is at or will be at the time of the service.

In one or some embodiments, the above orchestration of the respective entities may be managed automatically by a digital service model. In one or some embodiments, the digital service module may improve, such as optimize, the management in a highly individualized or tailored manner (as opposed to a standard manner), which may increase the complexity of the management process. To reduce complexity, the digital service module is structured into a central management system and one or more subsystems such as any one, any combination, or all of: a route management system; a spare parts management system; and a technician management system.

In one or some embodiments, the route management system may be configured to perform one or both of: (i) automatically generating a map that includes the route of one or more of: to transport the spare parts, tools and/or service technicians; or (ii) automatically transporting the spare parts, tools and/or service technicians (such as using a driverless vehicle, self-driving vehicles, or drones that transports any one, any combination, or all of the spare parts, the tools, or the service technicians).

In one or some embodiments, the spare parts management system may be configured to perform any one, any combination, or all of: (i) automatically generate an output on a screen at the correct or designated time requesting an operator to approve the order of a spare part that is needed; (ii) automatically order the spare part (e.g., by automatically sending a communication to a designated company that sends the part or automatically transports the part via drone or driverless vehicle to the location of service); or (iii) at least partly automatically transporting the spare parts (e.g., drone delivery; automatic loading of the spare part into a respective service vehicle of the technician; self-driving vehicle transporting the spare parts).

In one or some embodiments, the technician management system may be configured to automatically populate the calendar of a service technician and/or send a communication (e.g., an email, text message or the like) to the service technician to perform the service call.

Thus, in one or some embodiments, the central management system of the digital service module for the at least one service event may manage any one, any combination, or all of the route management system, the spare parts management system, or the technician management system for planning and implementing the at least one service event based on a designated strategy, with any one, any combination, or all of the route management system, the spare parts management system, or the technician management system using autonomous vehicles, self-driving vehicles, drones or the like in order to perform the respective operations including automatic routing, automatic transport of spare parts, or automatic transport of technicians. Merely by way of example, the routes generated by the route management system may be automatically loaded into the drones and/or autonomous vehicles in order to perform the automatic transport.

To bring the necessary flexibility into the digital service module, the management of the digital service module may be based on an optimization strategy, which may comprise a multi-target optimization strategy with a number of weighted optimization criteria.

In one or some embodiments, a focus is on time and/or quality. Regarding the aspect of time, it may be crucial to keep time schedules, such as to perform the technical service in an expected, mostly short time frame. Regarding the aspect of quality, it may be crucial to guarantee at least a predetermined quality level.

In one or some embodiments, one, some or all of those aspects may be weighted according to the optimization strategy, as noted above.

The resulting structure working with a specialized, particularly flexible approach to optimization, may be enormously effective, even with agricultural process changing during the implementation of the technical service.

In detail, a method is disclosed for providing a successful performance of an agricultural process by operating the agricultural working machine by a customer. A digital service module, which may be hosted by a server, comprises a success guarantee management system to improve (such as maximize) the probability of a successful agricultural process, wherein the occurrence of a technical problem of the agricultural machine may require the provision of a technical service to the agricultural working machine, wherein for coordinating the technical service, the digital service module may receive a request for service at least partly during performing the agricultural process (e.g., at least partly while the agricultural process is being performed, such as in preparation for the agricultural process, while performing the agricultural process, or after the agricultural process is performed in winding down performing the agricultural process). The request for service may include a problem description regarding a technical problem of the agricultural working machine. The server may comprises a database, wherein the database may include or have stored therein any one, any combination, or all of: information about the agricultural process; location of the agricultural working machine; locations of spare part(s) for the agricultural working machine; information about transport device(s) (such as part runners for the transport of parts); information about service vehicle(s) comprising tools for servicing the agricultural working machine; and information about service technician(s),

In one or some embodiments, the spare part(s) may include part(s) which may be located in service vehicles and/or located at central storage(s). The digital service module may comprise a data analytics system that is configured to derive service event(s) from the request for service. The service event(s) may include any one, any combination, or all of: the services needed to fix the problem of the agricultural working machine; the needed service technician(s); the needed tools; and the needed spare part(s). The digital service module may further comprise any one, any combination, or all of: a route management system configured to plan and/or implement the routes of transport devices (alternatively termed transportation devices) for transporting any one, any combination, or all of the spare part(s), the tool(s), and service technician(s); a spare parts management system configured to plan and/or implement the availability of the spare part(s) in parts storage device(s) (e.g., warehouses or other central storages); and a technician management system configured to plan and/or implement the availability of service technician(s). The digital service module may further comprise a central management system configured to coordinate any one, any combination, or all of: the route management system; the spare parts management system; and the technician management system, with the planning and implementing the service events based on a strategy (such as an optimization strategy). The strategy (such as the optimization strategy) may be a multi-target optimization strategy based on a number of weighted criteria (such as optimization criteria).

In one or some embodiments, the success guarantee management system may derive for each service event target performance criteria such as any one, any combination, or all of: target reaction time; target quality level; or target costs. The target performance criteria may be used as weighted criteria, such as highly weighted optimization criteria, within the optimization strategy in order to improve or maximize the probability of a successful agricultural process by meeting the optimization criteria.

In addition to the optimization criteria defined by the success guarantee management system, a number of preferred optimization criteria may be stored as default criteria in the database.

In one or some embodiments, the approval by the customer may be received before the automatic use of the target performance criteria as optimization criteria. This may make particular sense, if the customer has agreed to certain pricing for the technical service depending on meeting or not meeting the target performance criteria.

In one or some embodiments, the success guarantee management system may automatically estimate the target performance criteria based on the characteristics of the service event and/or on the database information. In essence, this may mean that the target performance criteria may be automatically estimated based on a comprehensive data basis, in order to end up with a realistically achievable result. In one or some embodiments, the information about the agricultural process may be as indicated above.

In one or some embodiments, an audit of the performed service event in view of being successful or not successful in the above noted sense may be automatically performed. This may be particularly important in case of a dynamic pricing strategy as discussed above.

In one or some embodiments, the central management system coordinates any combination or all of the route management system, the spare parts management system and the technician management system by realizing an information cycle, which may be followed by an optimizing cycle and an implementation cycle. In one or some embodiments, the central management system may switch from the implementation cycle back to the optimizing cycle responsive to automatically determining that the real implementation does not meet the optimization criteria defined in the optimization strategy. This may lead to an ongoing automatic optimization even during the implementation with accordingly good optimization results.

In one or some embodiments, the target performance criteria may be automatically estimated during the above-noted optimization cycle, as during the optimization cycle, a closer assessment of the implementation of the service event may be possible. In one or some embodiments, this is automatically performed in particular as the route management system then has evaluated realistic routes for the transport devices, which may lead to a more realistic estimation of the time needed for completion of the respective service event.

In one or some embodiments, the optimization strategy may also be directed to previously-planned service events, which may be being automatically implemented or which are to be automatically implemented. This may ensure that fewer or no time schedule collisions between service events occur and that possible synergies between similar service events may be being effectively used.

In one or some embodiments, any one, any combination, or all of the route management system, the spare parts management system and the technician management system, on implementation request, may each automatically perform detailed planning cycles. This may mean that the central management system may provide the basic guideline for implementation with its implementation requests, while the subsystems, on this basis, may automatically perform the detailed planning. This automatic centralized rough planning and decentralized automatic fine planning may lead to an exceptionally effective planning process.

For providing a technical service as noted above, the customer may be provided with a realistic time estimation until the starting time of the service event and may take one or more actions necessary to keep this promise to the customer without delay.

In one or some embodiments, an urgency level for the service event may be derived by the central management system from the information about the agricultural process, which may be stored in the database. This may mean that changes in the agricultural process, for example changes in the agricultural working machine and/or changes in weather and/or changes within the harvest may automatically lead to a change of the urgency level, which may be one of the optimization criteria.

In one or some embodiments, the optimization criteria may be weighted. Specifically, at least one change, such as a change in the agricultural process, may lead to a change in the weighting. The optimization may be automatically adapted to the agricultural process with its above-noted dynamics.

In one or some embodiments, the optimization cycle may rely on prediction information. Prediction information may be derived from any one, any combination, or all of: local historical data; global historical data; local live information; and global live information. It may well be that certain local conditions may lead to certain machine defects, which may be automatically predicted based on local historical data. This prediction information may help to further optimize the service event.

In one or some embodiments, the route management system may be central to the realization of the optimization strategy. In particular, changes in the route planning may result in optimization.

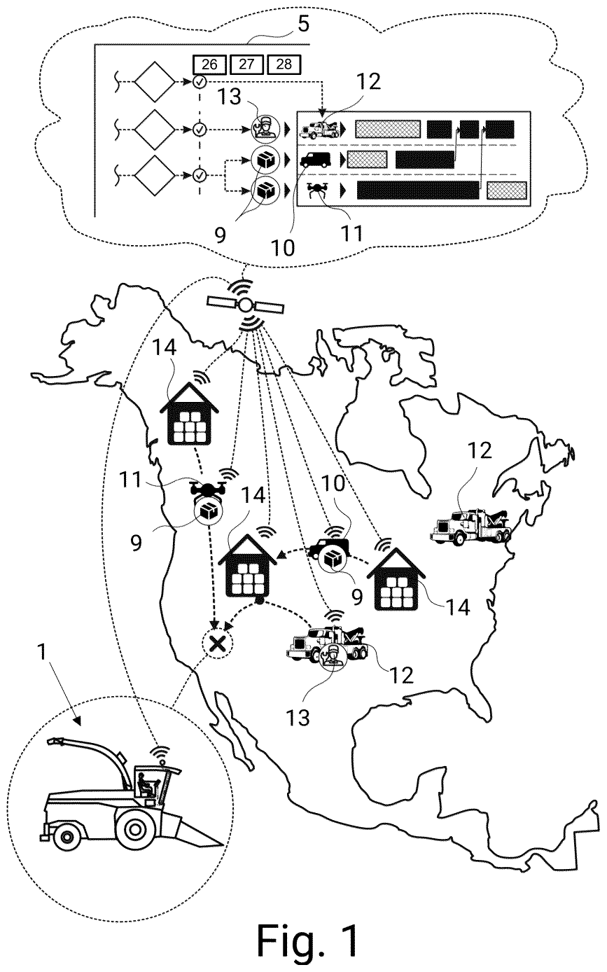

Referring to the figures, FIG. 1 illustrates an example of how a successful performance of an agricultural process by operating an agricultural working machine 1 by a customer 2 may be realized based on the disclosed method. In FIG. 1, a technical service has been planned by a digital service module 3 for the depicted agricultural working machine 1 marked with an “X”. In order to increase or maximize the probability of a successful performance of the agricultural process, the digital service module 3 comprises a success guarantee management system 4, as explained further below.

The agricultural working machine 1 may be operated within an agricultural process by the customer 2. The agricultural process may be a variety of types of processes, such as a harvesting process, a soil cultivation process or the like. In the following description, and as an example, the agricultural process is a crop harvesting process, which may be performed by a combine. Other agricultural processes are contemplated.

The occurrence of a technical problem of the agricultural machine may require the provision of the above-noted technical service to the agricultural working machine 1, which may compromise the goal of providing a successful performance of an agricultural process. As an example, the technical problem may be described as the generation of unusual squeaking sounds from the threshing unit of the combine.

The digital service module 3, and with it the success guarantee management system 4, may be hosted on a server 5 with a database 6. The server 5 may comprise computing and communication functionality, such as it may include at least one processor 26, at least one memory 27, and at least one communication interface 28. The at least one processor 26 and at least one memory 27 may be in communication (e.g., wired and/or wirelessly) with one another. In one or some embodiments, the processor 26 may comprise a microprocessor, controller, PLA, or the like. Similarly, the memory 27 may comprise any type of storage device (e.g., any type of memory). Though the processor 26 and the memory 27 are depicted as separate elements, they may be part of a single machine, which includes a microprocessor (or other type of controller) and a memory. Alternatively, the processor 26 may rely on the memory 27 for all of its memory needs. Still alternatively, the processor 26 may rely on a database (such as database 6) for some or all of its memory needs.

The memory 27 may comprise a tangible computer-readable medium that include software that, when executed by the processor 26 is configured to perform any one, any combination, or all of the functionality described herein, such as one or more parts of the digital service module 3. In this regard, any functionality described herein, such as (without limitation) with regard to the success guarantee management system 4, the data analytics system 15, the route management system 16, the spare parts management system 17, the technician management system 18, the central management system 19, the drone 11, the service vehicle 12, the prediction management system 22, customer (via a laptop computer, a smartphone, tablet or the like that includes a user interface, such as a touchscreen), or service technician (via a laptop computer, a smartphone, tablet or the like that includes a user interface, such as a touchscreen) may use the computing functionality described herein, such as the processor 26, the memory 27 and/or the communication interface 28.

Further, the communication interface 28 may be configured to communicate (e.g., wired and/or wirelessly) with one or more electronic devices. As one example, any one, any combination, or all of the following may communicate with one another via its respective communication interface 28: agricultural working machine 1; the server 5; customer 2 (via a laptop computer, a smartphone, tablet or the like); part runner 10; drone 11; service vehicle 12; service technician 13 (via a laptop computer, a smartphone, tablet or the like); data analytics system 15; route management system 16; spare parts management system 17; technician management system 18; central management system 19; or the prediction management system 22.

The processor 26 and the memory 27 are merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The digital service module 3 may be configured to automatically coordinate a technical service for the agricultural working machine 1. Increasing or maximizing the probability for the successful performance of the agricultural process, despite the technical problem, may be the responsibility of the success guarantee management system 4 as a part of the digital service module 3. Other technical problems are contemplated.

First, the digital service module 3 of the server 5 may receive (such as automatically receive) a request for service 7 during performing the agricultural process (e.g., in preparation for performing, during performing, or thereafter proximate in time to performing the agricultural process). This request may be made by the customer 3, for example via a customer support 8, or by the agricultural working machine 1 itself via a communication module. In one or some embodiments, all communication amongst different devices may be internet-based, for example.

In one or some embodiments, the request for service 7 is actually being made during the agricultural process. This may be, depending on the machine problem, while the agricultural working machine 1 is still running. The request for service 7 may include a problem description regarding a technical problem of the agricultural working machine 1. This problem description may include explicitly the service event to be performed including the necessary resources for fixing the problem. Alternatively, or in addition, the problem description may include a description of the machine problem in natural language, for example: “The threshing unit produces squeaking sounds”.

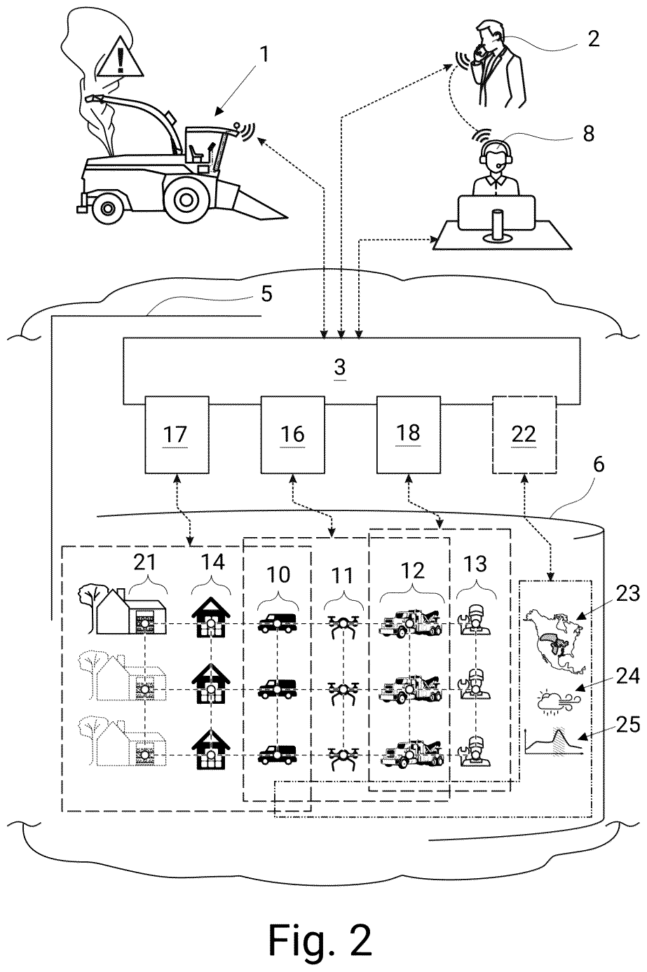

As noted above and shown in FIG. 2, the server 5 comprises a database 6. The database 6 may have stored therein information about any one, any combination, or all of: the agricultural process; the location of the agricultural working machine 1; locations of spare parts 8 for the agricultural working machine 1; information about transport devices (such as part runners 9 or drones 10) for the transport of parts; service vehicles 11 comprising tools for servicing the agricultural working machine 1; and information about service technicians 12.

The information about the agricultural process may include: information regarding the harvest, the crop, the soil or the like; and/or technical information about the agricultural working machine 1; and/or weather information. A typical information about the agricultural process may be any one, any combination, or all of: the work progress with regard to the harvest of a field; the change of the characteristic of the agricultural working machine 1 (which in the example may be the increase of the squeaking noise); or weather information (such as an approaching front carrying rain).

Often, a problem of the agricultural working machine 1 may require the exchange of spare parts 8 like a belt, a valve, a hydraulic pump, electronic components or the like. Those spare parts 8 may be located in any one, any combination, or all of: service vehicles 11; at central storage(s) 13; or the like.

The digital service module 3 may comprise a data analytics system 15 automatically deriving service events from the request for service 7. Those service events may include any one, any combination, or all of: the services needed to fix the problem of the agricultural working machine 1; the needed service technician 13; the needed tools; and the needed spare parts 8. In one or some embodiments, the data analytics system 15 comprises a simple rule-based system configured to extract the information about the necessary service event from the request for service 7. Alternatively, the data analytics system 15 may comprise a more sophisticated, AI-based system, that is trained to process natural language input. As a result, a service event, which is to be performed at the agricultural working machine 1, may be defined to include any one, any combination, or all of: the services needed to fix the problem of the agricultural working machine 1; the needed service technician 13; the needed tools; and the needed spare parts 8 as noted above.

In one or some embodiments, the disclosed system and method are configured to make sure that some or all resources for the service event are present within a predetermined amount of time at the agricultural working machine 1. In order to achieve this task, the digital service module 3 may comprise any one, any combination, or all of:
a route management system 16 configured to automatically plan and automatically implement the routes of transport device(s) for transporting any one, any combination, or all of: spare parts 8; tools; and service technicians 12;
a spare parts management system 17 configured to automatically plan and automatically implement the availability of the spare parts 8 in parts storage devices such as warehouses; and
a technician management system 18 configured to automatically plan and automatically implement the availability of service technicians 12.

In other words, the complex task of providing all those resources from different locations to the agricultural working machine 1 within a predefined timescale, may be automatically performed at least partially de-centrally by the route management system 16, the spare parts management system 17, and the technician management system 18.

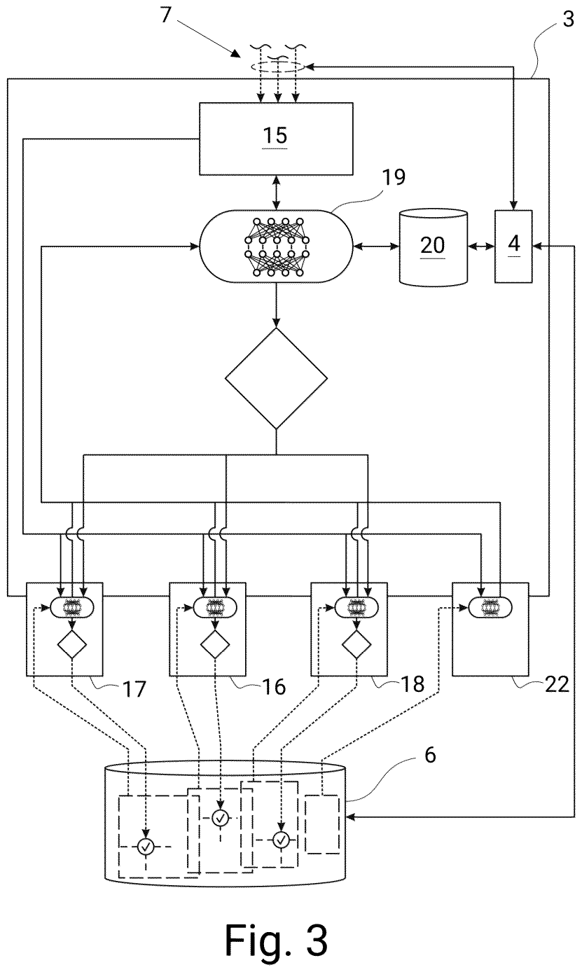

In one or some embodiments, the digital service module 3 may further comprise a central management system 19 configured to automatically coordinate one or more subsystems, such as any one, any combination, or all of: the route management system 16; the spare parts management system 17; and the technician management system 18 for planning and implementing the service events based on an optimization strategy. This is indicated in FIG. 2 and FIG. 3.

In one or some embodiments, the optimization strategy may comprise a multi-target optimization strategy based on a number of weighted optimization criteria 20. In one or some embodiments, the definition of the optimization criteria 20 may be understood in close connection or defined as part of the concept of success guarantee. In this regard, the definition of success, as part of the success guarantee, may in turn be used to define the optimization criteria 20.

In one or some embodiments, with regard to the concept of success guarantee to the customer 2, the digital service module 3 may comprise the success guarantee management system 4, which for one, some or each service event, may derive target performance criteria, such as any one, any combination, or all of: target reaction time; target quality level; or target costs. Further, the target performance criteria may be used as highly weighted, such as top weighted, optimization criteria 20 within the optimization strategy. This may mean that the optimization strategy may be parameterized such that the probability of success may be automatically increased or maximized by applying the above-noted multi-target optimization strategy.

Other optimization criteria 20 are contemplated. In one or some embodiments, the optimization criteria 20 may be dynamically and automatically changed at least partly during the implementation of the service event, for example, responsive to automatically determining that one or more aspects of the agricultural process have changed (such as changed more than a predetermined amount). This may, for example, be a weather change (e.g., responsive to automatically determining that the temperature has increased greater than a predetermined number of degrees or decreased greater than a predetermined number of degrees). Responsive to this automatic determination that one or more aspects of the agricultural process have changed, one or more aspects of the optimization may be changed, such as either the optimization criteria itself being used and/or the weighting or priority of the optimization, such as making the optimization criteria 20 “minimize reaction time between service request and starting time of the service event the top priority, while the optimization criteria 20 “Minimize costs for the service event” being a lower priority.

In one or some embodiments, the optimization criteria 20 may include any one, any combination, or all of:
reduce (or minimize) reaction time between service request and starting time of the service event; reduce (or minimize) costs for the service event; increase (or maximize) quality level of the service; or reduce (or minimize) waiting time of the service technician 13 for spare parts 9 at the agricultural working machine 1.

While most of those optimization criteria 20 are self-explaining, the optimization criteria 20 “Maximize quality level of the service” may comprise an interesting aspect: The situation may appear that there may be at least two alternatives to fix the problem of the agricultural working machine 1. One alternative may be the high (or a higher) quality, standard exchange of a spare part 9. In the present example, this may be the exchange of a belt of the threshing unit. The other alternative may be the repair of the existing part, such as trying to repair the belt, which may only be a preliminary solution and which may be considered a low (or a lower) quality solution. However, responsive to automatically determining that the agricultural process is almost finished (e.g., an automatic determination that the field subject to plowing is nearly entirely plowed), the optimization criteria 20 “Maximize quality level of the service” may be of low priority in favor of the optimization criteria 20 “Minimize reaction time between service request and starting time of the service event”. Here, it may become clear that the optimization based on a multi-target optimization strategy may be advantageous for meeting the needs of the agricultural process. Further, in this regard, the automatic dynamic or real-time determination of at least one aspect of the agricultural process (e.g., the amount of completion of the agricultural process and/or changed conditions (such as changed weather conditions)), may result in an automatic updating of the optimization, such as the automatically updated coordination of the one or more subsystems, such as any one, any combination, or all of: the route management system 16; the spare parts management system 17; and the technician management system 18 for planning and implementing the service events based on the updated optimization strategy.

In order to agree with the customer 2 on the targets to be achieved for the performance to be assessed as being successful, in one or some embodiments, the customer 2 may be automatically asked by the success guarantee management system 4 for approval, before the target is being used within the optimization strategy. For example, the success guarantee management system 4 may generate a graphical user interface (GUI) or a webpage for automatic sending to an electronic device (e.g., a laptop, smartphone, or the like) of the customer 2. In turn, the electronic device may output the GUI or webpage on a display (such as a touchscreen) to solicit input (e.g., requesting approval) from the customer 2. Responsive to the output, the customer 2 may provide the input (e.g., approval or disapproval). Accordingly in one or some embodiments, the target performance criteria may be transmitted to the customer 2 for approval, and after approval by the customer 2, may be used as highly weighted optimization criteria 20 within the optimization strategy. This transmittal and approval may be performed via various communication channels (e.g., wired and/or wirelessly), for example via the above-noted customer support 8.

In one or some embodiments, the target performance criteria may be estimated based on the one or more characteristics of the service event (e.g., the description of the technical problem) and on the database 6 information.

For example, the characteristics of the service event may include any one, any combination, or all of: the complexity of the service event (e.g., in terms of spare parts 9 to be organized); service technician(s) 13 to be relocated; and the technical complexity of the service itself. The success guarantee management system 4 may automatically evaluate the complexity of the service event, such as based on information requested from any one, any combination, or all of: the central management system 19; one or more subsystems such as any one, any combination, or all of: the route management system 16; the spare parts management system 17; and the technician management system 18.

In one or some embodiments, the database 6 information may provide another input for the generation of the target performance criteria. This information from the database 6 may not only be primarily directed to the agricultural process itself, but may also be directed to peripheral information such as any one, any combination, or all of: weather information; business information regarding the agricultural process; business information regarding the customer 2; information regarding local economic conditions; information regarding global economic conditions etc.

Based on part or all of this information, the success guarantee management system 4 may automatically generate the target performance criteria, such that those target performance criteria may realistically be met and therefore proposed to the customer 2 for approval, as discussed above.

In one or some embodiments, the target performance criteria may be estimated based on one or both of: the information about the agricultural process stored in the database 6 (e.g., information about the work progress within the agricultural process, such as the percentage completion of the agricultural process); or information about the weather conditions, etc. The information about the work progress may give an indication about the time frame in which the service event is to be completed and/or about the quality level needed to guarantee. As one example, near or close completion of the service event (e.g., more than 75% completed) may indicate that a repair of a part versus a replacement of the part (e.g., lower quality level versus higher quality level) may be warranted. In this regard, the analysis may indicate, factoring the completion and the quality level, the automatic recommended course of action so that the agricultural working machine 1 is sufficiently functioning until the completion of the service event.

In one or some embodiments, after completion of the service event, the success guarantee management system 4 may automatically check whether the target performance criteria have been met (e.g., whether a respective target performance criterium has performed within a predetermined amount or a predetermined percentage) and automatically evaluate the completion of the service event as being successful or not successful. Accordingly, the customer 2 may be automatically billed for the service depending on whether the service event is successful or is not successful.

An exemplary sequence of events is illustrated in FIG. 3. After receiving the request for service 7, the central management system 19 may automatically coordinate the route management system 16, the spare parts management system 17 and the technician management system 18 based on the optimization strategy.

As a first step, this may be automatically done by the central management system 19 in an information cycle, automatically sending information requests to the technician management system 18, the spare parts management system 17 and the route management system 16 to automatically retrieve information about any one, any combination, or al of: the locations and availability of instances of the needed service technician 13; the needed tools; or the needed spare parts 8; and to automatically retrieve information about possible routes for transport devices to directly or indirectly transport any one, any combination, or all of the needed service technician 13, the needed tools, or the needed spare parts 8 to the location of the service event.

In one or some embodiments, the expressions “service technician” 12, “tools”, “spare parts” and “transport devices” may represent not the actual existing component, but the type of component. An “instance” of the respective component, however, may represent the actual existing component. If, for example, the central management system 19 automatically derives that the service event requires a belt as a spare part 9, then this may mean just the type of the spare part 9, namely a belt with a certain product number. The instance of the belt, however, may be the belt actually being present in a storage device, such as a central storage 14 or even within a service vehicle 12.

Subsequently, the central management system 19 may automatically perform an optimization cycle based on the optimization strategy, in which the central management system 19 may automatically identify the respective instances and desired relocation requirements for at least part of those instances and the resulting routes for transport devices and automatically generate a time schedule for the implementation. It may well be that the instances of all resources needed are available and stored in a convenient location. Statistically, however, there is a probability that, for example, the instance of a needed spare part 9 is not available nearby the agricultural working machine 1 in a central storage 14 or warehouse or at a local stock at farm 21, such that a relocation of the spare part 9 has to be automatically initiated. For this, the central management system 19 automatically plans the relocation of the respective resource.

Based on the results of the optimization cycle, in an implementation cycle, the central management system 19 may automatically forward implementation requests including any one, any combination, or all of the identified instances, routes for transport devices and a time schedule to any one, any combination, or all of the technician management system 18, the spare parts management system 17, or the route management system 16.

Finally, based on the implementation tasks, any one, any combination, or all of the technician management system 18, the spare parts management system 17 and the route management system 16 automatically implementing the time schedule by automatically sending execution requests to the instances of the needed service technician 13, of the needed tools, of the parts storage devices and to the transport devices assigned to the identified routes. In the course of this implementation, the subsystems may automatically perform a decentralized planning of the implementation request. This may include the communication automatically sent between the subsystems in order to further optimize the sequence of actions regarding the above noted optimization strategy. For example, this may apply to the route management system 16, which may automatically coordinate the transport of all resources and may automatically and iteratively generate and assess route alternatives in view of the optimization strategy (including responsive to the automatic updating of the optimization strategy, as discussed above).

In one or some embodiments, the estimation of the target performance criteria may well be based on information provided by one or both of the central management system 19 and by the subsystems (e.g., any one, any combination, or all of: the route management system 16; the spare parts management system 17; and the technician management system 18), as particularly in the course of the optimization cycle, the information needed or used for the estimation of those target performance criteria may be present at or provided by those systems. Therefore, according to one or some embodiments, the target performance criteria may be automatically estimated during the above-noted optimization cycle.

In one or some embodiments, the optimization strategy may comprise the automatic coordination of the service event with prior service events, that are being implemented or that will be implemented, such that time schedule collisions are automatically prevented and that redundant routes are automatically combined. Again, the optimization strategy may be taken into account, automatically prioritizing one service event over another service event.

As noted above, after the optimization cycle, the technician management system 18, the spare parts management system 17 and the route management system 16, for the implementation of the implementation tasks, may each automatically perform detailed planning cycles. These detailed automatic planning cycles may be independent from each other. In order to allow the subsystems to effectively contribute to an optimized result, the subsystems may be given a predetermined freedom to automatically deviate from the respective implementation request, taking into account the optimization strategy.

As also noted above, the service events may be automatically managed with respect to time. In one or some embodiments, the route management system 16 may automatically generate an estimation of the starting time for the service event at the agricultural working machine 1, that the central management system 19 automatically forwards this planned estimated starting time to the customer 3 and that another optimization criteria 20 for the optimization strategy is “Minimizing the delay of the starting time for the service event with respect to the planned starting time”. This may mean that any deviation from the planned starting time is to be prevented. This additional optimization criteria 20 may be considered a high or low priority depending on the optimization strategy.

For the effective planning of the service event, it is proposed to realize an indication for the urgency for having the machine problem solved. Therefore, the central management system 19 may automatically derive an urgency indication from the customer 3 and/or from the information about the agricultural process stored in the database 6, for example depending on increasing wear of other aggregates of the agricultural machine induced by the problem to be solved by the service event. As another optimization criteria 20, the urgency lever, either manually set by the customer 3 or automatically set from within the agricultural process, may be defined. In the latter case, rules may be stored in the central management system 19 in order to automatically derive the respective urgency level.

In one or some embodiments, each optimization criteria 20 may be automatically weighted within the optimization strategy such that each optimization criteria 20 is assigned a priority value, which may be automatically changed in the course of the implementation of the service event responsive to a customer 3 request and/or responsive to automatically identifying a change of the agricultural process. The change of the agricultural process may be any change that may increase or decrease the urgency to solve the machine problem. Based on this priority value for each optimization criteria 20, the multi target optimization strategy may be executed.

In one or some embodiments, a prediction information may be automatically derived by a prediction management system 22 shown in FIG. 2. The prediction management system 22 may automatically generate prediction information regarding any one, any combination, or all of regional cultivation and harvesting characteristics, regional climate/weather characteristics, and/or regional soil characteristics and/or regional technical failure expectations based on any one, any combination, or all of regional data 23, weather data 24 and seasonal data 25 in combination with local and global live information. In one or some embodiments, the prediction information may be automatically taken into account during the optimization cycle. This is interesting, as all this information may help to manage the service event. For example, the cultivation and harvesting information may include information about the usual kind of crop being cultivated and the usual time of harvest during the year, which information may be used during optimization cycle, even if this information has not been forwarded by the customer 3. The usual weather characteristics may again be regarded in the optimization cycle, in order to estimate whether minimizing the time needed to fix the machine problem is of higher or lower priority.

In one or some embodiments, the route management system 16, on implementation task, automatically generates routes of transport devices to orchestrate the transport of instances of needed service technicians 12 and needed spare parts 8 to the agricultural working machine 1 to be serviced and automatically transmitting requests for execution to the respective transport devices, taking into account at least the optimization criteria 20 including one or both of:
reduce (or minimize) reaction time between service request and starting time of the service event; or reduce (or minimize) waiting time of the service technician 13 for spare parts 8 at the agricultural working machine 1.

Especially regarding the execution of routes by transport devices, numerous influences may be present to compromise meeting the time schedule. In this regard, the route management system 16 may automatically monitor the actual execution of the routes of transport devices and may automatically identify deviations from the time schedule, and depending on the degree of deviation automatically perform one or both of:
modifies the routes to meet the time schedule and transmits a request for execution of the new routes by the respective transport devices; or
sending a change request to the central management system 19 to perform an automatic optimization cycle to automatically generate a new implementation request.

The spare parts management system 17 may be responsible for the automatic availability of any spare parts 8 needed for performing the service event. Thus, in one or some embodiments, the spare parts management system 17 is configured to automatically perform any one, any combination, or all of:
automatically monitors the locations and availability of instances of spare parts 8 and introduces this information into the database 6; automatically organizes a predetermined inventory of spare parts 8 in storage devices such as central storages 13 by transmitting transport requests to the route management system 16; on an implementation request by the central management system 19, automatically organizes the availability of certain instances of spare parts 8 by transmitting a transport request to the route management system 16; or on an implementation request by the central management system 19, automatically organizes a handover of certain instances of spare parts 8 at a certain location.

The technician management system 18 may be responsible for the automatic availability of service technicians 12 and their respective qualification. Thus, in one or some embodiments, the technician management system 18 is configured to automatically perform any one, any combination, or all of:
automatically monitors the locations and availability of instances of service technicians 12 and the respective qualification and introduces this information into the database 6; automatically organizes a predetermined distribution of qualification of service technicians 12 by transmitting transport requests to the route management system 16 and/or to the instance of the service technician 13; or on an implementation request by the central management system 19, automatically organizes the availability of certain instances of service technicians 12 by transmitting a transport request to the route management system 16 and/or to the instance of the service technician 13.

According to the above, various communication and data exchange may automatically take place between any one, any combination, or all of the customer 3, the service technicians 12, the digital service module 3 the transport devices, the storage devices and the agricultural working machine 1, as is indicated in the drawings. For this, those entities may be assigned respective communication interfaces.

Moreover, the agricultural working machine 1 may be provided with sensors configured to detect the state of the machine and/or the respective mode of operation. This information may be automatically retrieved by the digital service module 3, as noted above. The same may apply to the transport devices and the storage devices. The customer 3 and the service technicians 12 may be assigned communication devices such as mobile phones.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 agricultural working machine
2 customer
3 digital service module
4 success guarantee management system
5 server
6 database
7 request for service
8 customer support
9 spare part
10 part runner
11 drone
12 service vehicle
13 service technician
14 central storage
15 data analytics system
16 route management system
17 spare parts management system
18 technician management system
19 central management system
20 optimization criteria
21 local stock at farm
22 prediction management system
23 regional data
24 weather data
25 seasonal data
26 processor
27 memory
28 communication interface

1. A computer-implemented method for performing an agricultural process by operating an agricultural working machine, the method comprising:
receiving, by a digital service module of a server for coordinating a technical service, a request for service during performing the agricultural process, the request for service including a problem description regarding a technical problem of the agricultural working machine that requires provision of the technical service to the agricultural working machine;
automatically accessing a database, wherein the database comprises information regarding the agricultural process, location of the agricultural working machine, one or more locations of spare parts for the agricultural working machine, information about one or more transport devices for transport of the spare parts, information about one or more service vehicles comprising tools for servicing the agricultural working machine, and information about one or more service technicians, wherein information regarding the spare parts comprise location in one or more service vehicles or which are located at one or more central storages;
automatically deriving, using a data analytics system of the digital service module and based on the request for service, at least one service event, wherein the at least one service event includes one or more services in order to fix the technical problem of the agricultural working machine, one or more service technicians to fix the technical problem, one or more tools used by the one or more service technicians to fix the technical problem, and one or more spare parts used by the one or more service technicians to fix the technical problem;
generating, using a success guarantee management system and for the at least one service event, a plurality of target performance criteria comprises one or more of target reaction time, target quality level, or target costs;
automatically generating and implementing, using a route management system of the digital service module for the at least one service event, one or more routes of the one or more transport device for transporting the one or more spare parts, the one or more tools and the one or more service technicians;
automatically planning and implementing, using a spare parts management system of the digital service module for the at least one service event, availability of the one or more spare parts in the at least one central storage or in the one or more service vehicles;
automatically planning and implementing, using a technician management system of the digital service module for the at least one service event, availability of the one or more service technicians; and
automatically coordinating, using a central management system of the digital service module for the at least one service event, the route management system, the spare parts management system and the technician management system for planning and implementing the at least one service event based on a strategy, wherein the strategy comprises a multi-target strategy based on the plurality of target performance criteria in order to increase probability of successfully performing the agricultural process.

2. The method of claim 1, wherein the plurality of target performance criteria comprise:
reduction in reaction time between service request and starting time of the service event;
reduction in cost for the service event;
increase in quality level of the service; and
reduction in waiting time of the service technician for spare parts at the agricultural working machine.

3. The method of claim 1, wherein the plurality of target performance criteria are transmitted to the customer for approval; and
wherein, responsive to receiving approval by the customer, using the plurality of target performance criteria as weighted optimization criteria within and optimization strategy.

4. The method of claim 1, wherein the plurality of target performance criteria are estimated based on one or more characteristics of the service event and on the information in the database.

5. The method of claim 1, wherein the plurality of target performance criteria are estimated based on the information about the agricultural process stored in the database, including the information about work progress of the agricultural process and the information about weather conditions.

6. The method of claim 1, wherein after completion of the service event, the success guarantee management system automatically checks whether the plurality of target performance criteria have been met and automatically evaluate completion of the service event as being successful or not successful based on whether the plurality of target performance criteria have been met.

7. The method of claim 1, wherein after the receipt of the request for service, the central management system automatically coordinates each of the route management system, the spare parts management system and the technician management system based on an optimization strategy by:
in an information cycle, automatically sending one or more information requests to the technician management system, the spare parts management system and the route management system to automatically retrieve information about the locations and availability of instances of the service technician needed, of the tools needed and of the spare parts needed, and to automatically retrieve information about potential routes for transport devices to directly or indirectly transport the instances to the location of the service event,
in an optimization cycle based on the optimization strategy, automatically identifying the respective instances and desired relocation requirements for at least part of the instances and the potential routes for transport devices and automatically generating a time schedule for the implementation;
in an implementation cycle, automatically forwarding implementation requests including the identified instances, the potential routes for transport devices and the time schedule to the technician management system, the spare parts management system and the route management system; and
based on the implementation requests, the technician management system, the spare parts management system and the route management system automatically implementing the time schedule by sending one or more execution requests to the instances of the service technician needed, of the tools needed, of the parts storage devices and to the transport devices assigned to the identified routes.

8. The method of claim 1, further comprising automatically estimating the plurality of target performance criteria at least partly during an optimization cycle.

9. The method of claim 1, wherein the multi-target strategy comprises a multi-target optimization strategy comprising automatic coordination of the service event with prior service events, which are currently being implemented or that will be implemented, such that time schedule collisions are automatically prevented and that redundant routes are automatically being combined.

10. The method of claim 1, wherein after an optimization cycle is performed, each of the technician management system, the spare parts management system and the route management system, for implementation of the request for service, each automatically perform detailed planning cycles with a predetermined freedom to deviate from the implementation of the request for service, taking into account the multi-target strategy.

11. The method of claim 1, wherein the route management system automatically generates an estimation of a starting time for the service event at the agricultural working machine;
wherein the central management system automatically forwards the estimation of the starting time to the customer; and
wherein the multi-target strategy comprises minimizing delay of the starting time for the service event with respect to the estimation of the starting time.

12. The method of claim 1, wherein the central management system automatically derives an urgency indication from one or both of the customer or from the information about the agricultural process indicative of increasing wear of other aggregates of the agricultural machine induced by the problem to be solved by the service event; and
wherein the plurality of target performance criteria comprise one or both of: urgency level set by the customer; or urgency level set from within the agricultural process.

13. The method of claim 1, wherein each of the plurality of target performance criteria is weighted within the multi-target strategy such that each of the plurality of target performance criteria is assigned a priority value, which is dynamically changed during implementation of the service event based on one or both of a customer request or a change of the agricultural process.

14. The method of claim 1, wherein the digital service module further comprises a prediction management system that automatically generates one or both of:
prediction information regarding one or more of regional cultivation and harvesting characteristics, regional climate/weather characteristics, or regional soil characteristics; or
regional technical failure expectations based on regional data, weather data, seasonal data, and local and global live information; and
wherein the prediction information is automatically taken into account during an optimization cycle.

15. The method of claim 1, wherein the route management system, responsive to receiving an implementation request, automatically generates the one or more routes of the one or more transport devices to orchestrate the transport of instances of service technicians needed and the spare parts needed to the agricultural working machine to be serviced and automatically transmits one or more requests for execution to the one or more transport devices, taking into account the plurality of target performance criteria of:
minimizing reaction time between the service request and starting time of the at least one service event; and
minimizing waiting time of the service technician for spare parts at the agricultural working machine.

16. The method of claim 1, wherein the route management system automatically and dynamically monitors actual execution of the one or more routes of the one or more transport devices and automatically identifies in real-time deviations from a time schedule; and
depending on a degree of deviation, wherein the route management system automatically:
modifies the one or more routes to generate one or more new routes in order to meet the time schedule and automatically transmits a request for execution of the one or more new routes by respective transport devices; and
sends a change request to the central management system to perform an optimization cycle to generate a new implementation request.

17. The method of claim 1, wherein the spare parts management system automatically:
monitors the locations and availability of instances of the spare parts and automatically saves the locations and the availability of instances of the spare parts into the database;
organizes a predetermined inventory of the spare parts in one or more warehouses by transmitting transport requests to the route management system;
responsive to an implementation request by the central management system, organizes the availability of certain instances of spare parts by automatically transmitting a transport request to the route management system;
responsive to an implementation request by the central management system, organizes a handover of certain instances of spare parts at a predefined location.

18. The method of claim 1, wherein the technician management system automatically:
monitors the locations and availability of instances of service technicians and the respective qualification and automatically saves the locations and the availability of instances of service technicians and the respective qualification into the database;
organizes a predetermined distribution of qualification of service technicians by automatically transmitting the one or more transport requests to one or both of the route management system or the instance of the service technician; and
responsive to an implementation request by the central management system, organizes the availability of certain instances of service technicians by automatically transmitting a transport request to one or both of the route management system or the instance of the service technician.
